(19) United States
(12) Patent Application Publication
(10) Pub. No.: US 2024/0388891 A1
(43) Pub. Date: Nov. 21, 2024

(54) Systems and Methods for Interconnecting Heterogenous Radios Over 3GPP-Based Communications Networks

(71) Applicant: MITRE Corporation, McLean, VA (US)

(72) Inventors: Feng Xie, McLean, VA (US); Shawn Lefebre, McLean, VA (US); Qing Mu, McLean, VA (US); Helen Chen, McLean, VA (US); Robbie Starr, McLean, VA (US); Venki Ramaswamy, McLean, VA (US)

(21) Appl. No.: 18/664,002

(22) Filed: May 14, 2024

Related U.S. Application Data
(63) Continuation-in-part of application No. 18/199,806, filed on May 19, 2023.

(51) Int. Cl. H04W 8/22; H04L 61/10; H04W 60/04; H04W 76/12

(52) U.S. Cl. CPC H04W 8/22; H04L 61/10; H04W 60/04; H04W 76/12

(57) ABSTRACT

A non-3GPP gateway is described for enabling a device without IP signaling capability to communicate on a 3GPP-based communications network. The non-3GPP gateway includes an IP adapter configured to map an IP address allocated by the 3GPP network with a non-IP capable device. The non-3GPP gateway further includes a signaling proxy configured to use a 3GPP credential to set up a session for sending and receiving data to and from a 3GPP core on behalf of the non-IP capable device, using the IP address mapped by the IP adapter.

### CROSS REFERENCE TO RELATED APPLICATION

The present application is a continuation-in-part of U.S. patent application Ser. No. 18/199,806, filed May 19, 2023 and titled “Systems and Methods for Enabling Non-3GPP Devices Without 3GPP Signaling Capability to Communicate on 3GPP-based Communications Networks,” which is incorporated herein by reference.

### TECHNICAL FIELD

The present application pertains to systems and methods enabling radios having different signaling capabilities to communicate with each other over 3GPP-based communications networks. More particularly, the present application discloses techniques by which a non-IP capable radio can be interconnected with other radios over 3GPP-based communications networks, such as a 5G core network.

### BACKGROUND

Tactical radios are a type of wireless communications equipment that are built to specifications for military or law enforcement use. Some tactical radios are ruggedized so as to be suitable for harsh environments, such as by being tolerant to shock, vibration, or immersion in water. Commonly, tactical radios are designed to provide secure communications, for example, to protect the confidentiality of military orders or intelligence that may be conveyed through use of the devices. Information sent over such radios may be encrypted to prevent interception, such as by using frequency hopping techniques or radio scrambling, and may include capabilities for anti-jamming, low probability of interception (LPI), or low probability of detection (LPD).

Typically, legacy tactical radios are designed for providing secure and reliable communications. For example, the radios might communicate over a short range using the Ultra High Frequency (UHF) band. Others might use electronic Counter-Counter Measures (ECCM) communicated on the Very High Frequency (VHF) band. Still others might use High Frequency (HF) broadband for beyond-line-of-sight (BLOS) communications. Devices that are classified as combat-net radio (CNR) might include capabilities for satellite communications. There are various examples of tactical and commercial radios in deployment that are designed for communicating with other radios of the same type. Such types of radios include Link 16, HF radio, MPU5, Troposcatter, Trellisware, CDL, TTNT, and Silvus, and each uses a certain type of radio communication. As an example, Trellisware units are software-defined radios with broad frequency and bandwidth coverages for global spectrum suitability in a TSM network. Silvus provides MIMO MANet communications. And as yet another example, a CDL radio uses Common Data Link, a secure protocol behind a full duplex, jam resistant digital data link. These radios and associated protocols are designed for providing secure and reliable communications with another radio of the same technology.

In typical cellular networks, Internet Protocol (IP) is the primary protocol used for data communications. An IP communication is connectionless and packet-based, where each packet contains the sender's internet address and the receiver's address in the IP packet header. 3GPP networks provide IP communications, and so the communications devices (such as mobile phones) are IP-capable. On the other hand, many types of legacy tactical radios are designed for secure communications without utilizing IP. A radio that is not preconfigured for IP communications does not have an associated IP address, and is not preconfigured for 3GPP communications. Depending upon its configuration, communications by a device that is not IP-capable might not be connectionless or packet-based.

In addition to tactical radios, there are also commercial radios, particularly legacy radios, in deployment that are not IP-capable and cannot communicate with other radios that operate using a different technology.

Although non-IP capable radios might be useful for their originally-intended purposes (e.g., secure point-to-point communications during a military operation), there may be instances when it would be beneficial for those same radios to additionally or alternatively engage in communications with other radios having different communication technologies. For example, there may be circumstances in which it is desirable to use a legacy tactical or commercial radio (which typically might be used for military or government purposes) when performing humanitarian relief efforts in which several different government branches would use different types of tactical radios to communicate with each other. In such scenarios, it would be beneficial to enable legacy, non-IP capable radios to interconnect with radios employing other technologies, but without changing the radio's hardware configuration.

In addition to legacy, non-IP capable radios, there are also IP-capable radios that are also not configured for 3GPP communications. The hardware or software in some of these IP-capable radios cannot be reconfigured or “upgraded” for 3GPP communications. In some scenarios, it also would be beneficial to enable legacy radios that are not configured for 3GPP communications to interconnect with radios employing other technologies, but without changing the radio's hardware configuration.

### SUMMARY

The following describes an adapter enabling a non-3GPP device without IP capability to communicate on a 3GPP-based communications network.

A non-3GPP gateway is described for enabling a device without IP signaling capability to communicate on a 3GPP-based communications network. The non-3GPP gateway includes an IP adapter configured to map an IP address allocated by the 3GPP network with a non-IP capable device. The non-3GPP gateway further includes a signaling proxy configured to use a 3GPP credential to set up a session for sending and receiving data to and from a 3GPP core on behalf of the non-IP capable device, using the IP address mapped by the IP adapter.

Additionally, the following discloses a method to be performed by a non-3GPP gateway for enabling a device without IP signaling capability to communicate on a 3GPP-based communications network. This method includes mapping, by an IP adapter, an IP address allocated by the 3GPP network with a non-IP capable device. The method also includes using, by a signaling proxy, a 3GPP credential to set up a session for sending and receiving data to and from a 3GPP core on behalf of the non-IP capable device, using the IP address mapped by the IP adapter.

### BRIEF DESCRIPTION OF THE DRAWINGS

Embodiments of the present disclosure will be described with reference to the accompanying drawings, in which:

FIG. 1 illustrates a network 100 including gateways that enable a non-IP capable/non-3GPP device to interconnect with 3GPP devices and other non-3GPP devices in accordance with embodiments of the present disclosure.

FIG. 2 is a high-level schematic illustrating how heterogeneous tactical radios can interconnect over a 5G Core Network.

FIG. 3 is a block diagram of a system through which a non-3GPP gateway, including an IP adapter (all the blocks except for 5G Signaling Proxy) and a signaling proxy, enable a non-3GPP/non-IP device to communicate through a 5G core network, in accordance with some embodiments.

FIG. 4 is a high-level schematic illustrating module interaction in a high-level design of an example non-3GPP Gateway 400 in accordance with embodiments of the present disclosure.

FIG. 5 is a high-level schematic of a network arrangement 500 in which heterogeneous tactical radios can interconnect over a 5G Core Network, according to additional embodiments of the disclosure.

FIG. 6 further depicts, in the arrangement of network components as depicted in FIG. 5, establishment of 5G sessions for non-IP UEs, according to embodiments of the disclosure.

FIG. 7 further depicts, in the arrangement of network components as depicted in FIGS. 5-6 the assignment of IP addresses and association of a non-IP UEs with the Non-3GPP Gateways, according to embodiments of the disclosure.

FIGS. 8 and 9 repeat the arrangement of network components as depicted in FIGS. 5-7 but additionally depict IP tunneling for serial data at the Non-3GPP Gateways, according to embodiments of the disclosure.

FIG. 10 is a flow diagram of operations performed by a Non-3GPP Gateway according to embodiments of the disclosure.

FIGS. 11 and 12 provide signal flows for establishing or deleting a 5G session over a Non-3GPP Gateway.

### DETAILED DESCRIPTION

The present disclosure enables a non-3GPP device (“user equipment,” or “UE”) without IP capability to communicate through a 3GPP network, such as a 5G Core Network. More specifically, for non-3GPP devices without IP capability, embodiments of the present disclosure use an IP adapter to become interconnected to different types of radios without expensive upgrades to existing radio equipment. Combining an IP adapter and a 3GPP signaling proxy into a non-3GPP Gateway provides a cost-effective solution to interconnect radios when such communications are needed.

The IP adapter as described in the present disclosure communicates with a signaling proxy to set up a link for sending and receiving data to and from the 5G core network on behalf of a non-IP device. The inclusion of an IP adapter, for example, in a non-3GPP gateway, can enable a non-IP capable, non-3GPP device to take advantage of features provided by a 3GPP network, including quality of service, roaming, and lower cost, without modifying the software or hardware of such devices.

As used herein, a “waveform” refers to the signal received at a physical layer of a device (e.g., user equipment, or “UE”).

A “network interface” refers to a hardware component that a UE uses to communicate via a particular communications system (e.g., WiFi, 5G, Satellite).

As used herein, “Non Access Stratum (NAS) Capable Device” refers to a device that contains the NAS software (aka, 5G signaling protocols) needed to establish a 5G session with the 5G core. The establishment of a session includes the establishment of a data path that provides IP transport from the UE to the 5G core to a data network accessible by the 5G core.

As used herein, “NAS Incapable Device” refers to a device that does not contain the NAS software needed to establish a 5G session with the 5G core.

As used herein, a “3GPP-Capable Device” is a device that has a radio that supports the 5G New Radio (NR) access technology and contains the NAS software.

As used herein, a “non-3GPP Device” refers to a device having a network interface that is incapable of communicating within the range of the spectrum allocated to 5G or is incapable of communicating using 5G signaling protocols. Under the context of “5G”, 3GPP and 5G are equivalent. 3GPP capable devices have both 5G NR radio waveform and 5G signaling protocols to connect to a 5G core network and thus do not need a proxy (as described below).

A non-3GPP device may be a hybrid device that includes both a 3GPP-capable network interface (e.g., 5G NR) and a non-3GPP network interface (e.g., WiFi).

Non-3GPP devices that do not have 5G NR radio waveforms but support 5G signaling protocols can use network functions such as N3IWF (non-3GPP Interworking Function in 5G core) as a non-3GPP access gateway to connect to a 5G core network, and so they do not require a proxy either. (N3IWF is one of four specified inter-working functions that non-3GPP devices can use, and they are used under different conditions.) Only those non-3GPP devices that do not support 5G signaling protocols (most likely, they do not have 5G NR radio waveform either), need to use a proxy to connect to the core. In summary, N3IWF allows non-3GPP radio waveforms to connect to the 5G core, whereas a proxy allows devices without 5G signaling capability to connect. The proxy is therefore used for such devices that do not have a 5G-capable radio interface and also cannot perform 5G signaling.

A “non IP-capable, non-3GPP” device is a non-3GPP device that additionally does not have the capability to communicate over IP. In other words, the device is configured such that its communication technology is not dependent on IP packet formats or protocols. In cellular networks, IP is the primary protocol used for data communication. However, certain special purpose radios, such as tactical radios, communicate point-to-point, communicate with a dedicated connection, or otherwise communicate without having associated IP addresses.

As used herein, “5G Credentials” are the information issued by a 5G provider to a subscriber (UE) to authenticate the subscriber as an authorized user of the services provided by the 5G core to that subscriber. They refer to Universal Subscriber Identity Module (USIM) and Subscriber Permanent Identifier (SUPI).

As used herein, a “proxy” is 5G signaling software that communicates over the NAS functional layer towards the 5G core. It also keeps track of the 5G credentials to use to authenticate UEs with the 5G core. Unlike the case of an UE authenticating directly with the 5G core where each UE has a unique 5G credential, the “proxy” may use a single 5G credential to establish a single 5G session on behalf of one UE or on behalf of many UEs. Thus, the 5G credentials may have one-to-one relationship to a UE (i.e., one 5G credential for one UE), one-to-many relationship (i.e., one 5G credential for many UEs), or many-to-many relationship (i.e., a set of 5G credentials for a non-equal set of UEs). The type of 5G credentials and UE relationship is policy based. All NAS-Incapable devices are required to use a proxy.

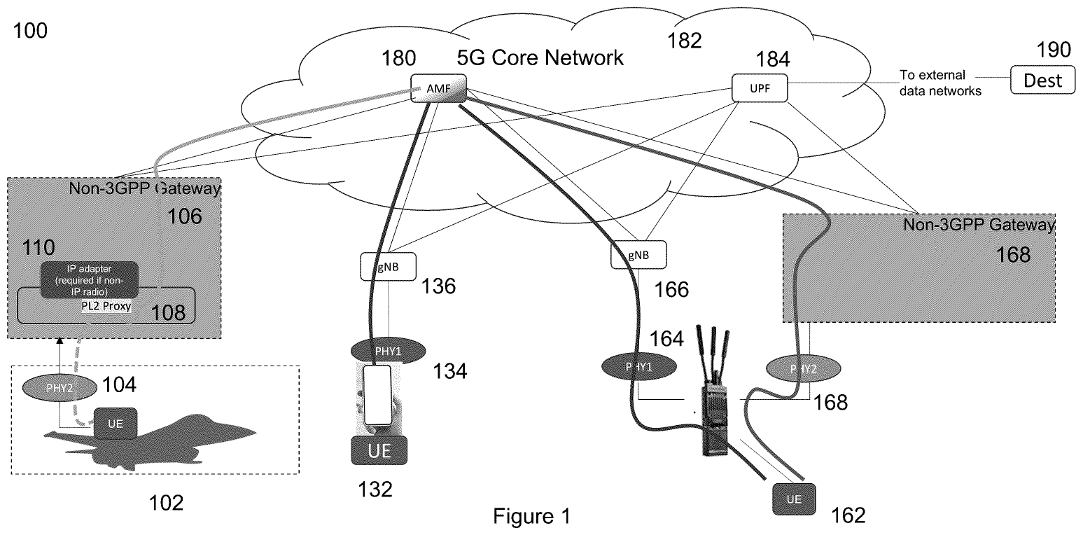

FIG. 1 illustrates a network 100 including gateways that enable non-IP capable/non-3GPP devices to interconnect with 3GPP devices and other non-3GPP devices in accordance with embodiments of the present disclosure. The network is access-agnostic in that it enables devices having different types of communication technologies to communicate with each other via different types of physical layers.

As shown in FIG. 1, network 100 includes a 5G core network 182. 5G core networks communicate with 5G UEs via gNodeB (“gNB”) equipment. A gNB, which stands for “Next-Generation Node B,” is a 5G Base Station using New Radio (“NR”) technology. A gNB transmits 5G signaling between a 5G UE and an AMF 180 (where “AMF” stands for Access and Mobility Management Function”) or UPF 184 (where “UPF” stands for User Plane Function). The UPF 184 can communicate information to or from UEs through the 5G Core, and can also communicate with external devices 190 on external networks.

In accordance with embodiments of the present disclosure, in addition to communicating with 5G UEs such as UE 132, the network 100 also can support communications with UE 102 and UE 162, where both communicate using a different technology than UE 132. Some UEs that can communicate via network 100 are 3GPP-capable whereas others are not, and some additionally are not IP-capable. In accordance with embodiments of the disclosure, network 100 provides flexibility to enable non-IP capable devices to become interconnected for communication with IP-capable devices over the 5G Core Network 182.

As depicted in FIG. 1, UE 132 can be a mobile device, such as a phone, that is an IP device configured for 3GPP communications. As such, UE 132 transmits and receives 5G signaling via gNB 136. From there, the signaling is communicated to AMF180 or UPF 184 in the 5G Core Network 182. 5G compliant PHY1 134 layer supports the 5G downlink (gNB-to-UE) and 5G uplink (UE-to-gNB). Accordingly, the pathway between UE 132 and the 5G core 182 as depicted in FIG. 1 is intended to reflect conventional 5G signaling.

Continuing with the example of UE 132 in FIG. 1, this 5G-capable device has access to a 5G credential (e.g., stored in a SIM card), and when using that 5G credential, the 5G UE may establish registration for access control to the 5G network (a control plane connection) and a Protocol Data Unit (PDU) session for user plane data communication with AMF 180 (Access and Mobility Management Function) and UPF 184 (User Plane Function) of 5G core network 182, respectively. As part of the process for establishing these connections, 5G core network 182 allocates an IP address for the UE. Subsequently, using the established user plane connection (and the allocated IP address), the 5G UE 132 may send and receive data to and from 5G core network 182 and/or to and from an external data network 190 via 5G core network 182. As used herein, the phrase “communicating through” 5G core network 182 refers to both communicating with a device that is part of 5G core network 182 (e.g., AMF, UPF, other UEs) as well as communicating with a device in the external data network 190 (e.g., public web server) that is accessible via the 5G Core Network.

In contrast with 5G-enabled UE 132, UE 102 in FIG. 1 is a radio that is not 5G-enabled, which can include a tactical radio or legacy commercial equipment. In one embodiment, UE 102 is a non-IP capable, non-3GPP radio. As depicted, UE 102 can be installed in an aircraft and can be configured for secure communications using a satellite network interface. As shown in FIG. 1 and in accordance with embodiments of the present disclosure, UE 102 communicates over PHY2, a physical layer that can be Department of Defense custom hardware and is distinct from PHY1 because it is not 5G capable. Over PHY2, UE 102 communicates with Non-3GPP Gateway 106, which provides a bridge between UE 102 and the 5G core 182

Non-3GPP Gateway 106 can include a signaling proxy 108 to enable the non-3GPP, NAS incapable device 102 to communicate through the 5G Core Network 182. A proxy is a network element that performs necessary signaling on behalf of an end user device to the 5G core. Put another way, a proxy is a component that connects non-3GPP NAS incapable end devices to a 5G core network. The proxy therefore sets up an internal connection between the non-3GPP Gateway and the 5G core. Upon establishing the connection, the tunnel is set up and a Linux kernel will use it as an interface. After that, the traffic received from UE is put into the tunnel to be sent to the 5G core. Accordingly, the proxy negotiates with the core to set up the tunnel, but the proxy does not play a role in forwarding traffic. The proxy's role is therefore in the control plane for setting up the interface.

Returning to FIG. 1, proxy 108 has access to at least one 5G credential, which proxy 108 uses to communicate with 5G core network 182 on behalf of one or more non-3GPP, NAS incapable devices. More specifically, proxy 108 uses an accessible 5G credential to establish control plane/user plane connection pairs with AMF 180 and UPF 184 of 5G core network 182, respectively. Subsequently, when non-3GPP Gateway 106 receives data from non-3GPP, NAS incapable device 102 intended for 5G core network 182 (i.e., destined for 5G core network 182 or external data network 190), non-3GPP Gateway 106 repackages (e.g., encapsulating as packets) the payload within the received data and transmits it towards 5G core network 182 using the established user plane connections.

The data received at non-3GPP Gateway 106 from non-3GPP, NAS incapable device 102 is considered to be intended for 5G core network 182 to communicate with a device accessible via 5G core network 182 (e.g., a device in external data network 190). Conversely, when non-3GPP Gateway 106 receives data from 5G core network 182 intended for non-3GPP NAS incapable device 102, non-3GPP Gateway 106 repackages the payload within the received data and transmits it to non-3GPP NAS incapable device 102.

Because the 5G Core Network 182 is an IP-based network but UE 102 is not IP-capable, the non-3GPP gateway 106 includes an IP adapter 110 that maps or indexes IP addresses allocated by the 5G core network 182 with associated devices. The IP adapter 110 can be incorporated into proxy 108 or it can be a distinct component of Non-3GPP gateway 106. Additionally, in some embodiments, IP adapter 110 can be external to Non-3GPP Gateway 106.

Using the IP adapter 110, a non-3GPP, NAS incapable, non-IP device 102 may be identified using an identifier that non-3GPP Gateway 106 can use to reach the device (distinct from the IP address allocated by 5G core network 182); for example, this identifier may be another IP address (distinct from the IP address allocated by 5G core network 182), a MAC address, an Automatic Link Establishment address for modern HF, and a calls sign used for old-fashioned HF or amateur radio. The received data at non-3GPP Gateway 106 from 5G core network 182 is considered intended for non-3GPP NAS incapable device 102 when the IP headers of the received data packets include as their destination an IP address mapped to non-3GPP NAS incapable device 102.

Proxy 108 is transparent to 5G core network 182. That is, 5G core network 182 is unaware that proxy 108 is acting as an intermediary to non-3GPP NAS incapable device 102. From the perspective of 5G core network 182, the control plane/user plane connections are made directly with a UE device. However, due to the fact that Proxy 108 may use its own information or generated information to establish control plane/user plane connections, the identity of a non-3GPP NAS incapable device 102 (i.e., its device ID, MAC address etc.) may be hidden from 5G core network 182.

In some embodiments, non-3GPP Gateway 106 may intercept data intended for the non-3GPP NAS incapable device 102. That is, in place of, or in addition to, repackaging and transmitting the data received from 5G core network 182, non-3GPP Gateway 106 may process the data for itself. For example, the data from 5G core network 182 may be an instruction to terminate control plane/user plane connections associated with a particular 5G credential. In this example, non-3GPP Gateway 106 may not transmit the data to non-3GPP NAS incapable device 102. Instead, it may process the instruction to terminate the specified control plane/user plane connections or attempt to reestablish the connections. In some embodiments, the data from 5G core network 182 may be intended for non-3GPP NAS incapable device 102 that is only capable of transmitting data (i.e., a unidirectional device or a device in a unidirectional mode). In these embodiments, non-3GPP Gateway 106 may be configured to save the received data (e.g., for a batch transfer to the non-3GPP NAS incapable device 102 at a later time) or ignore the data.

An example of a command that the 5G core can issue to a UE that the proxy can intercept and process could be a paging or alert signal issued by the 5G core to 3GPP devices. The 5G core will deliver these messages/signals to a non-3GPP Gateway. However, since non-3GPP NAS incapable devices served by the non-3GPP Gateway do not support these functionalities, the non-3GPP Gateway either silently drops these signals/messages or translates to the corresponding device-specific messages before sending them to the non-3GPP NAS incapable end devices.

In some embodiments, Proxy 108 may have access to a plurality of 5G credentials. In these embodiments, it may select a 5G credential among the plurality of credentials based on the identity of non-3GPP NAS incapable device 102, the type of traffic/protocol, and/or predetermined rules/policy. In some embodiments, a 5G credential may be dynamically selected (e.g., based on traffic type, rules/policy, etc.) at the time non-3GPP Gateway 106 receives data from 5G core network 182 or from non-3GPP NAS incapable device 102. Alternatively, or additionally, a predetermined non-3GPP NAS incapable device 102 may be associated with a 5G credential when non-3GPP Gateway 106 makes the control plane/user plane connections using the 5G credential.

In some embodiments, proxy 108 may be a part of the communications system for non-3GPP NAS incapable device 102 (e.g., WiFi, proprietary wireless system). For example, if non-3GPP NAS incapable device 102 uses a CDMA technology, proxy 108 may be a part of a CDMA wireless tower that receives wireless signals from such a device. In another example, if non-3GPP NAS incapable device 104 is a WiFi device, proxy 150 may be a part of WiFi Access Point.

FIG. 1 additionally depicts UE 162, which is a hybrid device that includes both a 5G NR network interface and another non-3GPP network interface (e.g., WiFi). In this example, UE 162 can communicate via alternating technologies, both of which are IP-capable. When UE 162 communicates over PHY1 164, it transmits 5G signals via gNB 166 to either AMF 180 or UPF 184 of the 5G Core Network 182. In this regard, UE 162 functions analogously to UE 132. When UE 162 communicates over PHY2 168, it reaches the 5G Core Network 182 via a Non-3GPP Gateway 168, analogously to UE 102. Non-3GPP Gateway 168 may include a proxy, similarly to the depiction of Non-3GPP Gateway 106. In this example however, unlike UE 102, UE 162 is an IP-capable device and so it does not require the use of an IP adapter.

The network 100 of FIG. 1 illustrates an evolution of capabilities in which different radios can communicate over different physical layers. Particularly, the figure illustrates three different types of radios, each of which can communicate using the 5G Core Network, but based upon different adaptations. By including a proxy and also an IP Adapter, the network enables a radio, such as a tactical radio, that is not IP-capable,

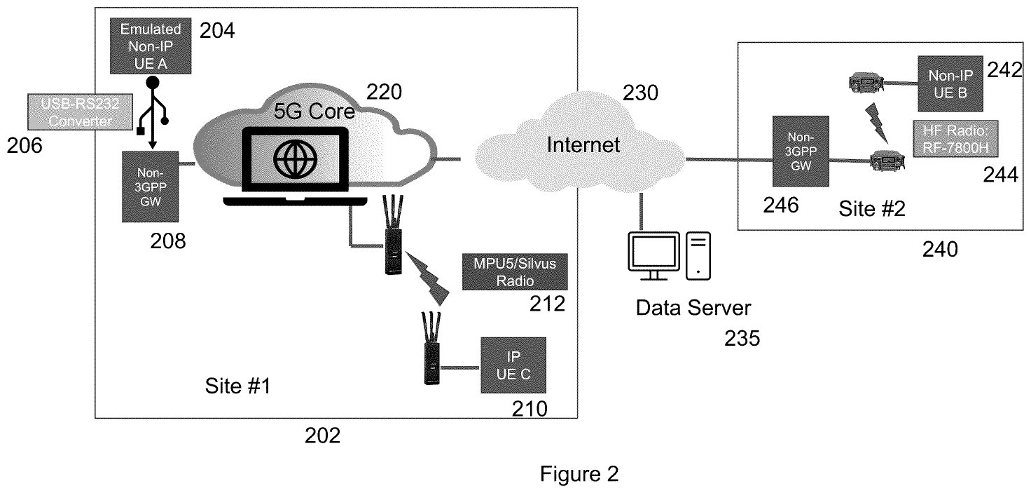

FIG. 2 is a high-level schematic illustrating how heterogeneous tactical radios can interconnect over a 5G Core Network. In this figure, user equipment is located at two sites, Site #1 202 and Site #2 240. In this figure, UE A 204 and UE C 210 are located at Site #1 202 and can utilize the 5G Core Network 220 to communicate with UE B 242 in Site #2 240 to exchange, for example, text messages.

More particularly, UE A 204 is an emulated, Non-IP capable radio that communicates with the 5G Core Network 220 by using an RS-232 connection (via USB-RS232 converter 206) to interface with non-3GPP Gateway 208. The 5G Core Network 220 can communicate signals from UE 204 over the Internet 230 to Site #2 240.

UE C 210 is an IP-capable radio, and so it does not require an IP adapter. Rather, this radio utilizes a MPU5/Silvus Radio 212 to connect to the 5G Core 220. IP UE C 210 communicates via NAS protocols with N3IWF in 5G Core 220.

Finally, at Site #2 240, UE B 242 is a non-IP capable radio, which interfaces via an HF Radio RF-7800H 244 to an non-3GPP Gateway 246 to communicate over the Internet 230 to the 5G Core 220.

Accordingly, both Non-IP capable UEs 204 and 242 and an IP-capable radio 210 can all communicate over the 5G Core 220, where UE B 242 utilizes the Internet 230 to reach the 5G Core 220.

The non-3GPP Gateways identified in FIGS. 1 and 2 rely on whatever unique identifier is associated with each non-IP device, such as a call-sign, DoD IUID, etc. Serial interfaces, such as RS232 interfaces, can be used to connect the non-3GPP Gateway with the non-IP capable radios. Using these serial interfaces, the data can be transferred as text, and a frame/message structure can be defined. The IP adapter can be developed under Unbuntu Linux 20.04 LTS with kernel 5.8 or later.

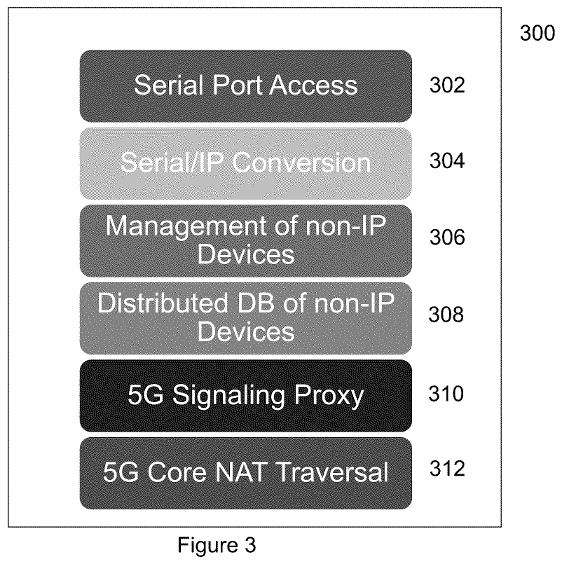

At a high level, the IP adapter and associated non-3GPP Gateway, can have six functional blocks or modules. As illustrated in FIG. 3, non-3GPP Gateway 300 has blocks for: Serial Port Access 302, Serial/IP Conversion 304, Management of non-IP Devices 306, Distributed database of non-IP devices 308, a 5G Signaling Proxy 310, and 5G Core NAT Traversal 312.

Serial Port Access block 302 provides capability for read/write from/to serial ports with the defined message/frame structure.

Serial/IP Conversion block 304 provides capability for converting between serial data and IP packets, which are routed through the 5G core and the data network.

The Management of non-IP Devices block 306 provides capability for detecting attach/detach of a serial device and maintaining the affiliation of the non-3GPP Gateway and non-IP devices.

The Distributed database of non-IP devices block 308 synchronizes with its peers on other non-3GPP Gateways by exchanging affiliation information between non-IP devices and the serving non-3GPP Gateways.

The 5G Signaling Proxy block 310, as described above, triggers establishment/tear-down of the 5G connections on behalf of non-IP devices.

Lastly, the optional NAT Traversal block 312 penetrates the 5G Cores for end-to-end communication between two non-IP devices attached to different 5G networks.

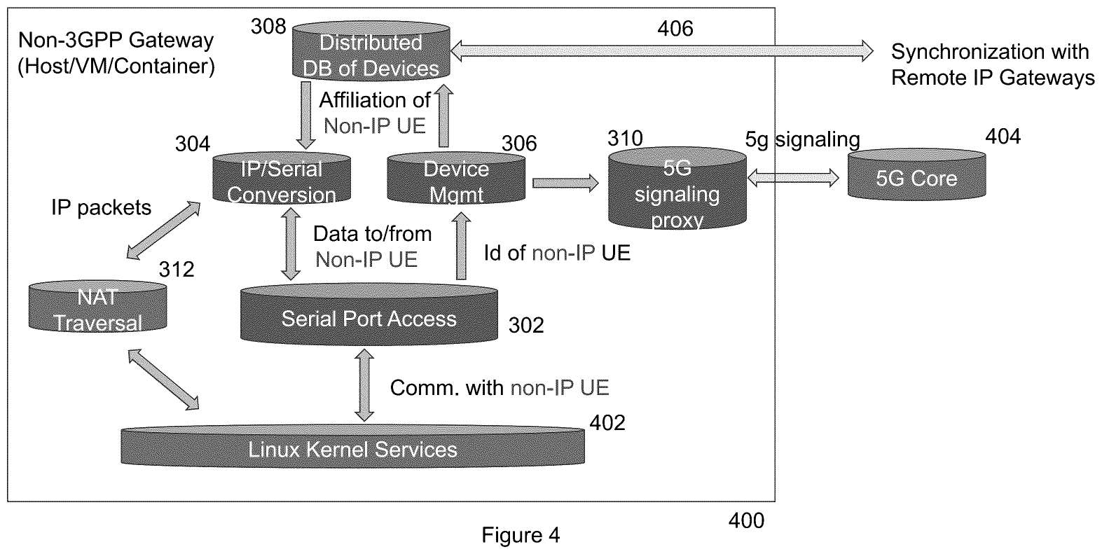

FIG. 4 is a high-level schematic illustrating module interaction in a high-level design of an example Non-3GPP Gateway 400 in accordance with embodiments of the present disclosure. For consistency, modules that were described with reference to FIG. 3 are presented with the same element numbers.

As can be seen in FIG. 4, the Serial Port Access block 302, which provides capability for read/write from/to serial ports with the defined message/frame structure, communicates with the Serial/IP Conversion block 304, the Management of non-IP Devices block 306, and the Linux Kernel Services block 402.

Particularly, Serial Port Access block 302 provides the identifier for a non-IP capable radio to the Management of non-IP Devices block 306, which triggers the 5G Signaling Proxy 310 to establish a tunnel with the 5G Core Network 404. As depicted in FIG. 4, the communication between Device Management 306 and the 5G Signaling Proxy 310 is in one direction, from block 306 to the proxy 310. When a UE attaches, that attachment is detected by device management block 306. There does not need to be a return communication. If the UE moves away, the device manager 306 will detect that and send a signal to the proxy 310 telling it to break down the connection.

The Management of non-IP Devices block 306 also adds identifier information of local Non-IP User Equipment to the Distributed Database of non-IP Devices block 308. The Distributed database 308 keeps track of non-IP capable UEs. Each base station can have a non-3GPP Gateway. When a non-IP UE is getting service on one base station but now has roamed to another, the network needs to keep track of which base station is serving that device. Likewise, when a message needs to go to a non-IP capable mobile device, the network needs to keep track of where it went. To accomplish this, on every non-3GPP Gateway, there is a database that tracks the locally attached UEs. The Distributed Database 308 exchanges the local identifier information with the Distributed Database of non-IP devices on other non-3GPP Ggateways such that, when all the Distributed Databases in the network are in synchronization, every non-3GPP Gateway is aware of all the Non-IP User Equipment in the network and their affiliated non-3GPP Gateways. The IP serial conversion block 304 converts serial data into IP packets and then decides where to send the packet. The packet needs to be sent to another non-3GPP Gateway that serves the destination UE. To determine where the message is to be sent, information is retrieved from the Distributed Database 308, which identifies the destination UE and its serving non-3GPP Gateway. The source gateway then will forward the packet to the destination gateway, which will further forward it to the destination UE. With this two-step forwarding technique, the packet is always forwarded from the UE to the source gateway, then to the destination gateway, and then to the destination UE.

FIG. 4 also depicts NAT Traversal block 312, which is optionally provided. “NAT,” or network address translation, can be used if a carrier is replacing a private address with a public one. NAT traversal is utilized for two non-3GPP Gateways, which are assigned private IP addresses by two different 5G core networks, to communicate with each other. In such an embodiment, NAT traversal provides a public IP address for each non-3GPP Gateway because its private address cannot be used across different 5G core networks. The public IP addresses are used by NAT traversal to establish a UDP tunnel penetrating different 5G core networks between the two non-3GPP Gateways. If a NAT Traversal block 312 is utilized, IP packets are communicated to it from the IP/Serial conversion block 304. The packets are placed into a UDP tunnel by the NAT Traversal block 312 and sent to the destination non-3GPP Gateway at the other end of the tunnel. The NAT Traversal block 312 in turn communicates with the Linux Kernel Services block 402, which manages UDP tunnels for NAT traversal. If a NAT Traveral block 312 is not utilized when non-3GPP Gateways are assigned public IP addresses or connected to the same 5G core network, the IP/serial conversion block 304 directly communicates with the Linux Kernel Service block 402.

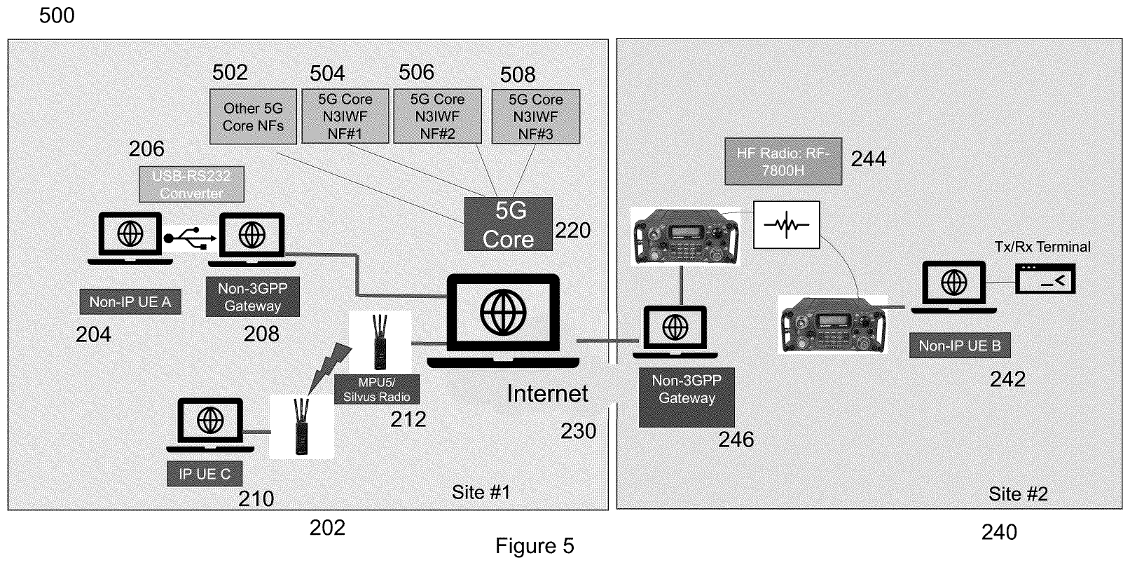

FIG. 5 is a high-level schematic of a network arrangement 500 in which heterogeneous tactical radios can interconnect over a 5G Core Network, according to additional embodiments of the disclosure. Similar to FIG. 2, in this figure, user equipment is located at two sites, Site #1 202 and Site #2 240. For consistency, modules that were described with reference to FIG. 2 are presented with the same element numbers. In this figure, UE A 204 and UE C 210 are located at Site #1 202 and can utilize the 5G Core Network 220 to communicate with UE B 242 in Site #2 240 to exchange, for example, text messages.

As described previously with reference to FIG. 2, at Site #1, 202, UE A 204 is a device, which uses an emulated, Non-IP capable radio to interface with non-3GPP Gateway 208 by using an RS-232 connection (via USB-RS232 converter 206). Also at Site #1, 202, UE C 210 is an IP-capable and NAS-capable device, and so it does not require an IP adapter, and instead it utilizes a MPU5/Silvus Radio 212 to connect to the 5G Core 220. At Site #2 240, UE B 242 is a non-IP capable device, which interfaces via an HF Radio RF-7800H 244 to an non-3GPP Gateway 246, to communicate over the Internet 230 to the 5G Core 220.

The 5G Core 220 has other 5G Core network functions (“NFs”) 502 and also multiple 5G Core Non-3GPP Interworking Function (“N3IWF”) NF #1 504, NF #2 506, and NF #3 508. N3IWF connects non-3GPP Gateways or non-3GPP NAS-capable UEs to 5G cores. Each N3IWF may serve one or more Gateways/UEs depending on configuration. This enables the Non-IP User Equipment (UE A 204 and UE B 242) to communicate with each other and with other Non-3GPP NAS-capable User Equipment (UE C 210).

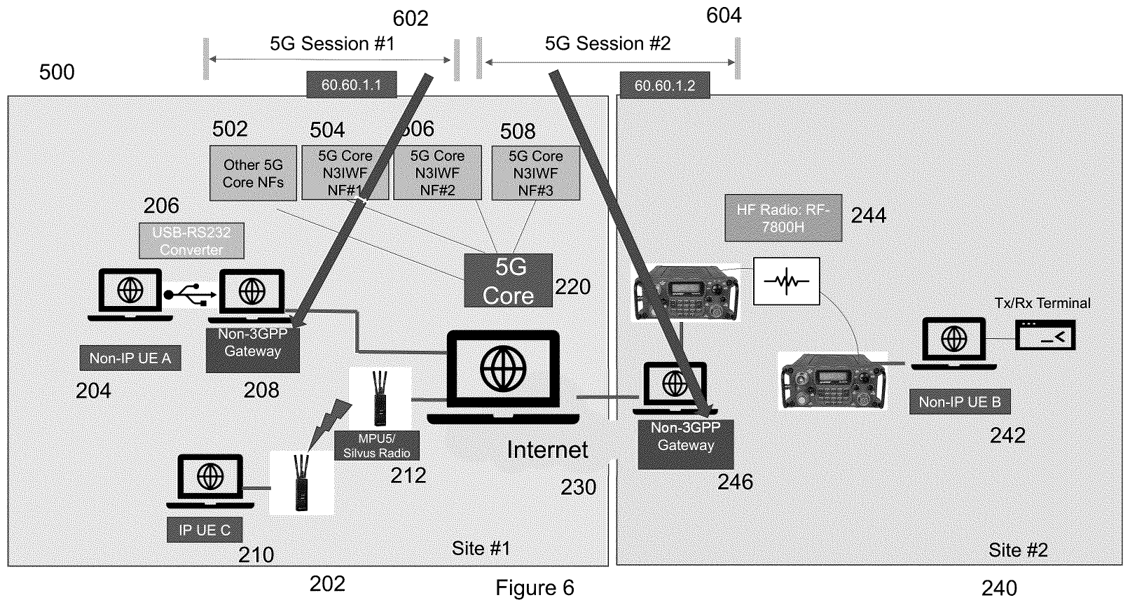

FIG. 6 is the same arrangement of network components as depicted in FIG. 5 but additionally depicts how 5G sessions are established for Non-IP devices. As can be seen, non-3GPP Gateway 208 is utilized for establishing 5G Session #1 602 for Non-IP UE A 204, and non-3GPP Gateway 246 is utilized for establishing 5G Session #2 604 for Non-IP UE B 242. In this scenario, non-3GPP Gateway 208 associates IP address 60.60.1.1 assigned by the 5G core 220 with Non-IP UE A 204 and IP Gateway 246 associates IP address 60.60.1.2 assigned by the 5G core 220 with Non-IP UE B 242. These IP addresses will be used for communicating over the 5G Core 220.

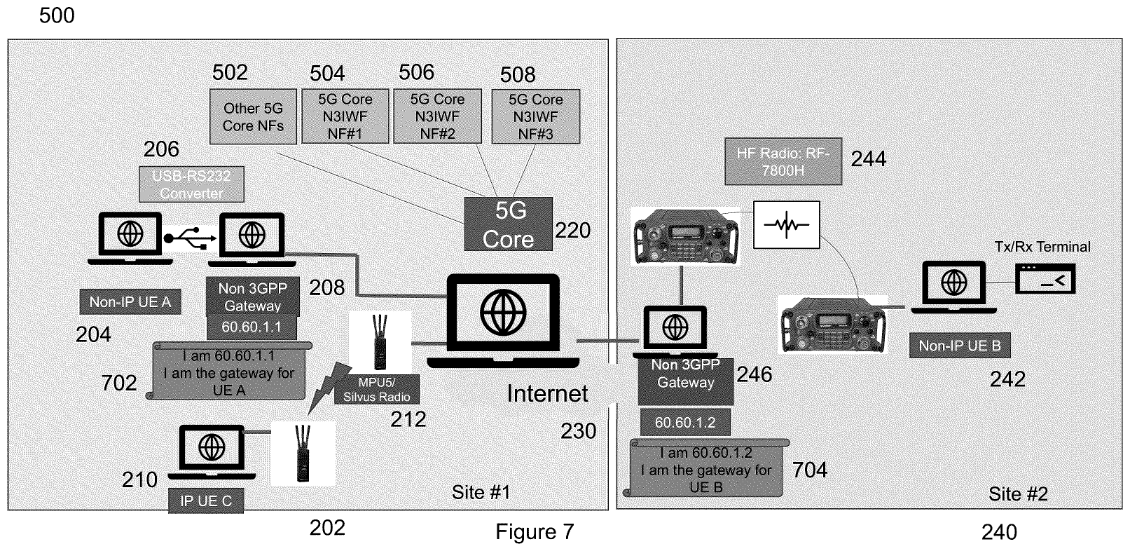

FIG. 7 provides the same arrangement of network components as depicted in FIGS. 5-6 but additionally depicts a synchronization of the distributed database on two non-3GPP Gateways for their affiliated non-IP User Equipment. Non-3GPP Gateway 208 informs non-3GPP Gateway 246 of its affiliation with UE A 204 by sending a message 702 and non-3GPP Gateway 246 does the same by sending a message 704. The messages 702 and 704 include the IP address of the non-3GPP Gateways assigned by the 5G core 220 (60.60.1.1 for non-3GPP Gateway 208 and 60.60.1.2 for non-3GPP Gateway 246) and the non-IP User Equipment identifiers (UE A for 204 and UE B for 242). In this manner, outgoing messages from Non-IP UE A 204 are transmitted on the 5G Core Network as having come from 60.60.1.1 and incoming messages for Non-IP UE A 204 are addressed to 60.60.1.1 over the 5G Core Network. Likewise, outgoing messages from Non-IP UE B 242 are transmitted on the 5G Core Network 220 as having come from 60.60.1.2 and incoming messages for Non-IP UE B 242 are addressed to 60.60.1.2 over the 5G Core Network.

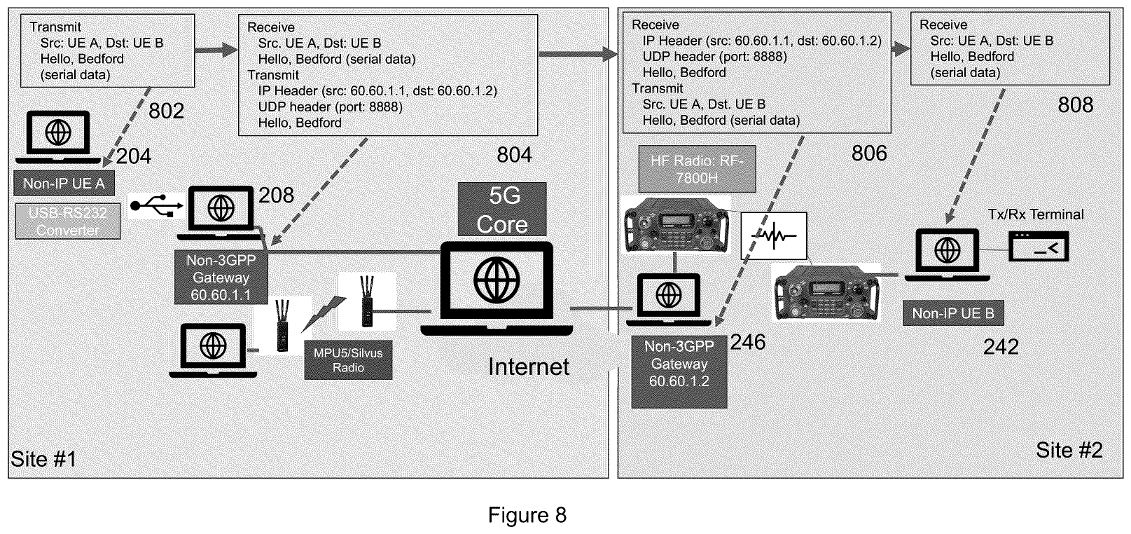

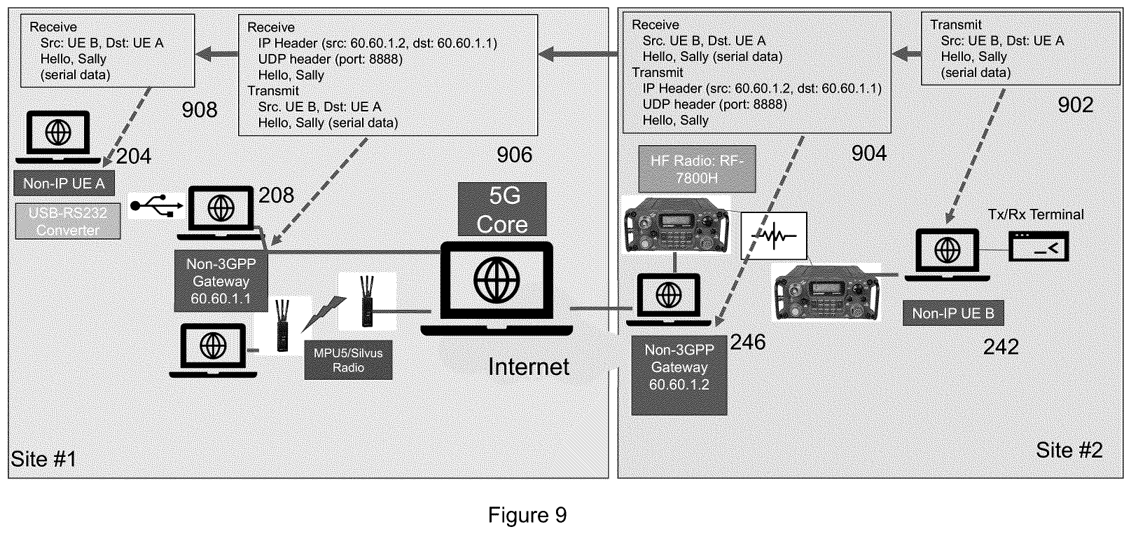

FIGS. 8 and 9 repeat the arrangement of network components as depicted in FIGS. 5-7 but additionally depict the IP tunneling for serial data at the non-3GPP Gateways. In FIG. 8, a message is communicated from non-IP UE A 204 to non-IP UE B 242 by means of two non-3GPP Gateways and the 5G Core. In FIG. 9, a reply message is communicated back from non-IP UE B 242 to non-IP UE A 204. Through the non-3GPP Gateways, these messages are communicated by converting the data to/from serial data and associating the non-IP identifiers for the non-IP UEs with the IP addresses of the affiliated non-3GPP Gateways.

In FIG. 8, Non-IP UE A 204 transmits a message with serial data to Non-IP UE B 242-“Hello Bedford.” The message 802 generated by Non-IP UE A 204 indicates the message destination (e.g., “Dst: UE B”) and can indicate the message source (e.g., “Src: UE A”). The transmit message also provides serial data of the message to be sent (e.g., “Hello, Bedford”). The transmit message is transmitted to the non-3GPP Gateway 208.

Upon receiving the transmit message 802, non-3GPP Gateway 208 associates the source Non-IP UE identifier with its IP address (e.g., 60.60.1.1), and generates a UDP message 804 to transmit over the 5G Core. By searching its Distributed Database of devices, non-3GPP Gateway 208 identifies the affiliated non-3GPP Gateway, i.e., non-3GPP Gateway 246, for the message destination, i.e., UE B. The transmitted UDP message includes the IP header with the IP address of the source non-3GPP Gateway (e.g., “src: 60.60.1.1”) and also the destination non-3GPP Gateway (e.g., “60.60.1.2”), UPD header information (e.g., port 8888) and the message to be transmitted “Src: UE A, Dst: UE B, Hello, Bedford.” This message is then communicated over the 5G Core.

The destination associated with IP address 60.60.1.2 is non-3GPP Gateway 246 in Site #2. Upon receiving message 806, non-3GPP Gateway 246 unpacks the message and decodes—the identifier for the destination UE. The non-3GPP Gateway 246 then generates a message in serial data to be transmitted to the non-IP devices, in this case, non-IP UE B 242, via HF Radio: RF-7800H. Upon receiving the message “Hello, Bedford,” the two non-IP UEs have been interconnected over the 5G Core by means of the non-3GPP Gateways.

In FIG. 9, Non-IP UE B 242 transmits a response message with serial data to Non-IP UE A—“Hello Sally.” The message 902 generated by Non-IP UE B 242 indicates the message destination (e.g., “Dst: UE A”) and can indicate the message source (e.g., “Src: UE B”). The transmitted message also provides serial data of the message to be sent (e.g., “Hello, Sally”). The transmit message is transmitted to the non-3GPP Gateway 246.

Upon receiving the transmitted message 902 (via HF Radio RF-7800H), IP Gateway 246 associates the source Non-IP UE identifier with its IP address (e.g., 60.60.1.2) and generates a UDP message 904 to transmit over the 5G Core. By searching its Distributed Database of devices, non-3GPP Gateway 246 identifies the affiliated non-3GPP Gateway, i.e., non-3GPP Gateway 208, for the message destination, i.e., UE A. The transmit UDP message includes the IP header with the IP address of the source non-3GPP Gateway (e.g., “src: 60.60.1.2”) and also the destination non-3GPP Gateway (e.g., “60.60.1.1”), UPD header information (e.g., port 8888) and the message to be transmitted “Hello, Sally.” This message is then communicated over the 5G Core.

The destination associated with IP address 60.60.1.1 is non-3GPP Gateway 208 in Site #1. Upon receiving message 906, non-3GPP Gateway 208 unpacks the message and decodes the identifier for the destination UE. The non-3GPP Gateway 208 then generates a message in serial data to be transmitted to the non-IP devices, in this case, to non-IP UE A 204. Upon receiving the message “Hello, Sally,” the two non-IP UEs have been interconnected over the 5G Core by means of the IP Gateways.

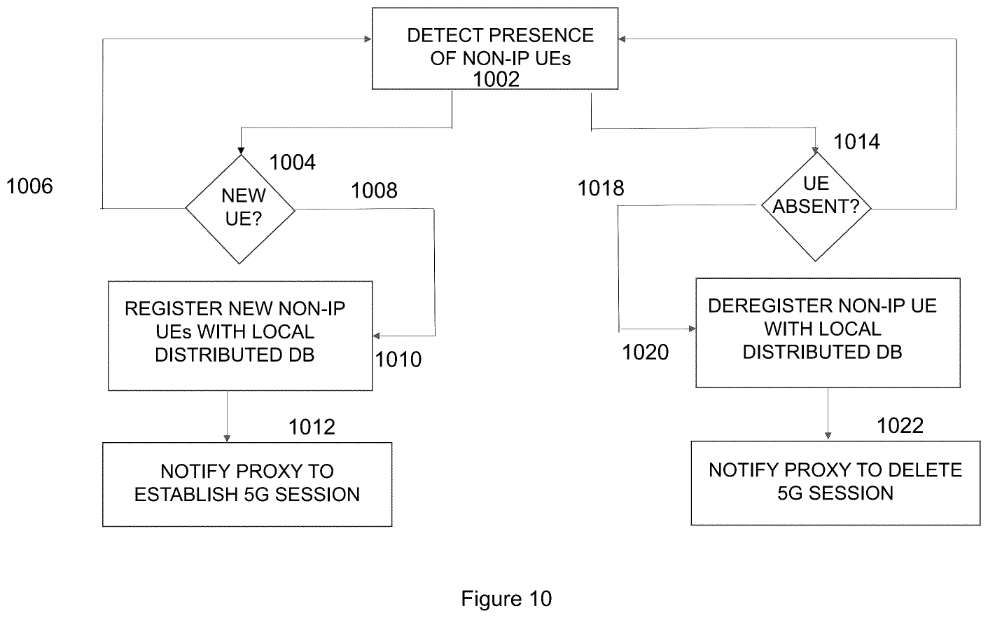

FIG. 10 is a flow diagram illustrating device management functionality for a non-3GPP Gateway according to embodiments of the present disclosure, such as Non-3GPP Gateway 400 in FIG. 4. At 1002, the Gateway detects the presence and absence of non-IP UEs by monitoring messages from the Serial Port Access (e.g. 302 in FIG. 3). In particular, the device can identify the UE identifier by inspecting the source attribute of the messages. A check (at 1004) is made for any new UEs. If no UE is detected, the system continues (at 1006) to search for any changes regarding the presence/absence of UEs 1002. If it is determined (at 1004) that there is a new UE, then (at 1008) the Gateway registers the new non-IP UE with the local Distributed DB of Devices (at 1010).

At 1012, the Non-3GPP Gateway notifies the 5G signaling proxy to establish a 5G session with the 5G core on behalf of any non-IP UEs. In a first option, there is one 5G session established per every non-IP UE. In a second option, there is one 5G session per non-3GPP Gateway for all local non-IP UEs.

Also at 1002, the Gateway is monitoring for registered non-IP UEs that appear to have become absent. Upon determining (at 1014) that a UEs has left, the Gateway's logic (at 1018) causes the Gateway to deregister the Non-IP UE with the local distributed database (at 1020). Next, the Gateway notifies the proxy to delete the 5G session with the 5G core for that Non-IP UE (at 1022). In one option, the Gateway removes the 5G session for the absent non-IP UE. In a second option, the Gateway removes the 5G session when the last non-IP UE leaves.

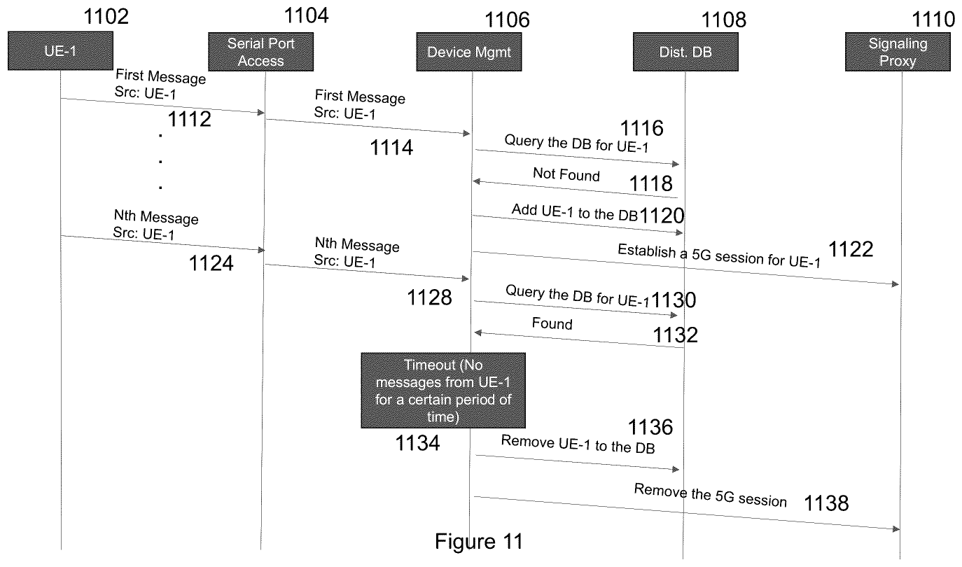

FIG. 11 provides a logic flow for device management between a UE (UE-1 1102), and the Non-3GPP Gateway's Serial Port Access (1104), Device Management (1106), Distributed Database (1108), and Signaling Proxy (1110), in which there is a one 5G session for every non-IP UE. In this logic flow, a first message from UE-1 (1112) is transmitted to Serial Port Access and then forwarded (1114) to Device Management. From there, Device Management queries (1116) the Distributed Database for UE-1, and if not found, a “not found” message 1118 is returned. From there, Device Management adds UE-1 to the Distributed Database (1120) such that Device Management can then establish a 5G session (1122) for UE-1. Subsequent to this registration, when additional messages are transmitted from UE-1 (via 1124 and 1128), the resulting query to the Distributed Database (1130) returns confirmation that the UE-1 was “found” (1132) so as to provide the communication. Upon determining (1134) that UE-1 has not sent additional messages within a predetermined period of time, the Device Management removes UE-1 from the Distributed Database (1136) and the Device Management removes the 5G session via the Signaling Proxy (1138).

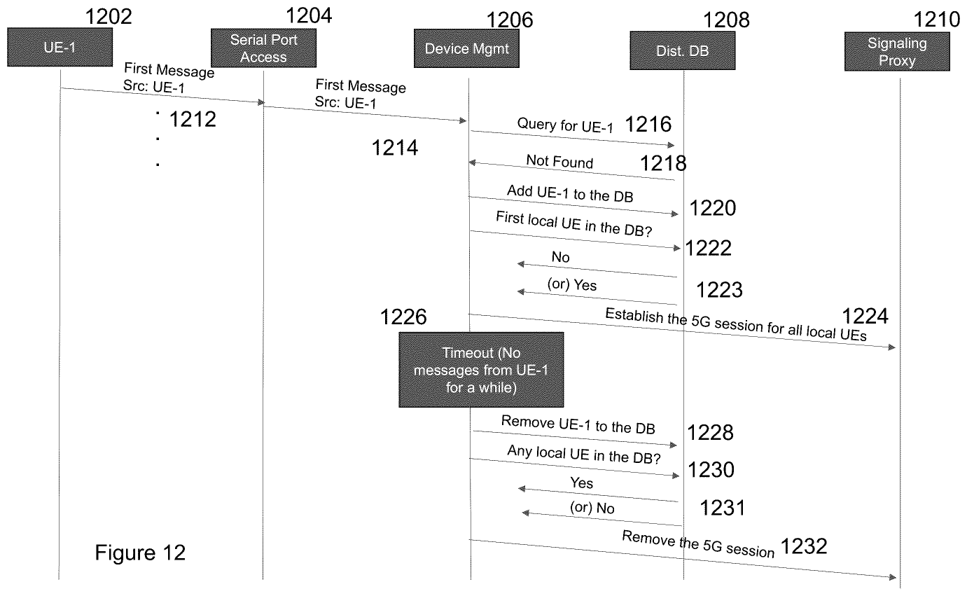

FIG. 12 provides a logic flow for device management between a UE (UE-1 1202), and the Non-3GPP Gateway's Serial Port Access (1204), Device Management (1206), Distributed Database (1208), and Signaling Proxy (1210) according to a second option in which there is a one 5G session per Non-3GPP Gateway. In this logic flow, a first message (1212) from UE-1 is transmitted to Serial Port Access and then forwarded (1214) to Device Management. From there, Device Management queries (1216) the Distributed Database for UE-1, and if not found, a “not found” message 1218 is returned. From there, Device Management adds UE-1 to the Distributed Database (1220). Device Management next queries the Distributed Database (1222) as to whether UE-1 is the first local UE that is in the database. Depending on the response message (1223), yes or no, the Device Management causes the Signaling Proxy to establish a 5G session for UE-1. If it is determined (at 1226) that UE-1 has not sent additional messages within a predetermined period of time, the Device Management removes UE-1 from the Distributed Database (1228). The Device Management additionally checks (1230) whether any local UE remains in the database. Depending on the response (1231) communicated by the Distributed Database (yes or no), the Device Management signals (1232) the Signaling Proxy to remove the 5G session.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. In particular embodiments, a non-transitory computer- or machine-readable medium may be encoded with instructions in the form of machine instructions, hypertext markup language based instructions, or other applicable instructions to cause one or more data processors to perform operations. As used herein, the term “machine-readable medium” (or “computer-readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

In the descriptions above and in the claims, phrases such as “at least one of” or “one or more of” may occur followed by a conjunctive list of elements or features. The term “and/or” may also occur in a list of two or more elements or features. Unless otherwise Implicitly or Explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in methods, systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A non-3GPP gateway for enabling a device without IP signaling capability to communicate on a 3GPP-based communications network, comprising:
an IP adapter configured to map an IP address allocated by the 3GPP network with a non-IP capable device; and
a signaling proxy configured to use a 3GPP credential to set up a session for sending and receiving data to and from a 3GPP core on behalf of the non-IP capable device, using the IP address mapped by the IP adapter.

2. The non-3GPP gateway according to claim 1, wherein the IP adapter further comprises a distributed database of non-IP capable devices, which synchronizes with peer databases on other non-3GPP gateways by exchanging affiliation information between non-IP capable devices and serving non-3GPP gateways.

3. The non-3GPP gateway according to claim 2, wherein the IP adapter further comprises a management of non-IP capable devices module, which triggers the signaling proxy to establish a tunnel with the 3GPP core.

4. The non-3GPP gateway according to claim 3, wherein the management of non-IP capable devices module adds identifier information of local non-IP capable devices to the distributed database of non-IP capable devices to track non-IP capable devices.

5. The non-3GPP gateway according to claim 4, wherein the IP adapter further comprises an serial/IP conversion block configured to convert between serial data and IP packets that are routed through the 3GPP core.

6. The non-3GPP gateway according to claim 5, wherein the IP adapter further comprises a serial port access block that provides an identifier for a non-IP capable device to the management of non-IP devices block.

7. The non-3GPP gateway according to claim 6, wherein the signaling proxy is transparent to the 3GPP core and the identity of the non-IP capable device is hidden from the 3GPP core.

8. The non-3GPP gateway according to claim 6, wherein, when messaging from the serial port access indicates the presence of a new non-IP capable device, the non-3GPP gateway registers the new non-IP capable device with the local distributed database of non-IP capable devices, and the signaling proxy establishes a 3GPP session with the 3GPP core on behalf of the registered non-IP capable device.

9. A method to be performed by a non-3GPP gateway for enabling a device without IP signaling capability to communicate on a 3GPP-based communications network, comprising:
mapping, by an IP adapter, an IP address allocated by the 3GPP network with a non-IP capable device; and
using, by a signaling proxy, a 3GPP credential to set up a session for sending and receiving data to and from a 3GPP core on behalf of the non-IP capable device, using the IP address mapped by the IP adapter.

10. The method according to claim 9, further comprising synchronizing, via a distributed database of non-IP capable devices in the IP adapter, with peer databases on other non-3GPP gateways by exchanging affiliation information between non-IP capable devices and serving non-3GPP gateways.

11. The method according to claim 10, further comprising triggering, via a management of non-IP capable devices module in the IP adapter, the signaling proxy to establish a tunnel with the 3GPP core.

12. The method according to claim 11, further comprising adding, via the management of non-IP capable devices module, identifier information of local non-IP capable devices to the distributed database of non-IP capable devices to track non-IP capable devices.

13. The method of claim 12 further comprising converting, via a serial/IP conversion block, between serial data and IP packets that are routed through the 3GPP core.

14. The method of claim 13 further comprising providing, via a serial port access block, an identifier for a non-IP capable device to the management of non-IP devices block.

15. The method of claim 14, wherein the signaling proxy is transparent to the 3GPP core and the identity of the non-IP capable device is hidden from the 3GPP core.

16. The method of claim 15, further comprising, when messaging from the serial port access indicates the presence of a new non-IP capable device, registering the new non-IP capable device with the local distributed database of non-IP capable devices, and establishing, via the signaling proxy, a 3GPP session with the 3GPP core on behalf of the registered non-IP capable device.
